(19) United States
(12) Patent Application Publication
(10) Pub. No.: US 2007/0285428 A1
(43) Pub. Date: Dec. 13, 2007

(54) Self-refreshing display controller for a display device in a computational unit

(75) Inventors: Mark J. Foster, Palo Alto, CA (US); Mary Lou Jepsen, Boston, MA (US); James Gettys, Carlisle, MA (US); V. Michael Bove JR., Wrentham, MA (US)

Correspondence Address: William L. Botjer, P.O. Box 478, Center Moriches, NY, 11934, US

(73) Assignee: ONE LAPTOP PER CHILD ASSOCIATION, INC., CAMBRIDGE, MA (US)

(21) Appl. No.: 11/726,785

(22) Filed: Mar. 23, 2007

Related U.S. Application Data
(60) Provisional application No. 60/785,066, filed on Mar. 23, 2006.
(60) Provisional application No. 60/785,065, filed on Mar. 23, 2006.
(60) Provisional application No. 60/906,122, filed on Mar. 9, 2007.

(51) Int. Cl. G06F 15/16

(52) U.S. Cl. 345/503

(57) ABSTRACT

A method, system and computer program product for a display system driving a display device is provided. The display system includes a processor, a primary display controller, a secondary display controller and the display device. The primary display controller receives display data that is sent by the processor. The primary display controller also drives the display device when the processor sends new display frames. When these display frames are sent by the processor continuously, control of the display device is switched to the secondary display controller, which is optimized for a low-power operation.

### RELATED APPLICATIONS

This application claims priority of U.S. Provisional Patent Application No. 60/785066 entitled “Self-Refreshing Display Controller for a Portable Computer”, filed on Mar. 23, 2006, which is incorporated by reference as if set forth herein in its entirety.

This application also incorporates by reference co-pending applications, U.S. Provisional Patent Application No. 60/785,065, filed Mar. 23, 2006, titled, ‘Artifact-Free Transitions Between Dual Display Controllers’ by Mark J. Foster and U.S. Provisional Patent Application No. 60/906,122 filed Mar. 9, 2007, titled, ‘Artifact-Free Transitions Between Dual Display Controllers’ by Mark J. Foster.

### BACKGROUND OF THE INVENTION

The present invention relates in general to the field of display devices in computational units. More specifically, the present invention relates to a method and system for refreshing display devices in computational unit.

Computational units use a display device to present information to a user. The display device is an interface between the computer and the user. Examples of display devices include, but are not limited to, Cathode Ray Tube (CRT) monitors, Liquid Crystal Display (LCD) monitors, plasma screens, and Organic Light Emitting Diodes (OLEDs). A display controller, which is present in the computational unit, obtains an input signal from a processor. The display controller processes the input signal and provides refresh data that refreshes the display device.

The refresh data is stored in a refresh memory of the display controller. In some systems, the refresh memory of the display controller is integrated with the processor RAM. This is known as a Unified Memory Architecture. In other systems, the display controller has its own RAM controller for refresh memory, independent of the processor RAM. The refresh data present in the refresh memory includes the color values of each pixel present in each line of the display device. The total amount of memory required to store the refresh data depends on the resolution of the display device. This resolution can be defined as the physical number of columns and rows of pixels that form the display. In addition, the total amount of memory required to refresh the display device depends on the color depth. The color depth comprises the number of bits used to represent the color of a single pixel. In a Unified Memory Architecture, the display device directly accesses the refresh data from the refresh memory of the processor. The processor drives much larger memories to support Basic Input/Output System (BIOS), Operating System (OS), and various other application programs. The amount of memory required for the operations of the processor is typically greater than the memory required by a display controller to refresh the display device in a Unified Memory Architecture.

The power required to drive the refresh memory can be stated as P=CVˆ2 F. Here C denotes the capacitance of the memory capacitor and V its voltage, and F the frequency of the memory clock. The power consumed to refresh the memory is directly proportional to the memory size. Further, additional power is required to run a memory arbitration unit that is used to share the main memory resource of the processor between the processor and the display device. As a result, power consumption increases while the display devices in the Unified Memory Architecture are being refreshed.

Moreover, in many computational units, display controllers are integrated with the processor. Such computational units do not allow the processor to be powered off when the display device no longer needs to be refreshed because of the absence of user input. This is caused by the common electronics associated with the dual-use memory system. As a result, power consumption increases further when the display devices are being refreshed, even during periods when the processor is inactive.

In light of the above data, there is a need for a method and system, which avoids the use of large memories, for refreshing a display device. Such a method and system should also be able to refresh the display device without requiring power to run the high-speed memory arbitration unit. Further, such a method and system should allow the processor to be powered off when the display does not require to be refreshed. In addition, there is a need for a method and system that is capable of autonomously powering down the display device after a prolonged period of inactivity, as well as reactivating the display device on resumption of user activity, independent of the processor.

### SUMMARY

An object of the present invention is to provide a method and system for a display system driving a display device.

Another object of the present invention is to provide a method and system for driving a display device without processor intervention.

Another object of the present invention is to provide a method and system for saving power consumption while a display device is being refreshed.

Another object of the present invention is to provide a method for synchronizing a primary and secondary display controller.

Yet another object of the invention is to eliminate the need for expensive and dedicated hardware, thereby making the invention ideal for use in cost- and power-sensitive applications.

In order to achieve the foregoing objectives, and in accordance with various embodiments of the present invention, as broadly described herein, various embodiments of the present invention provide a method and system for a display system driving a display device. The display system includes a processor, a primary display controller, a secondary display controller, and the display device. The primary display controller receives the display data sent by the processor and drives the display device when the processor sends new display frames. When the same display frames are sent by the processor continuously, the control of the display device is switched to the secondary display controller, which is optimized for low-power operation.

### BRIEF DESCRIPTION OF THE DRAWINGS

Various embodiments of the present invention will hereinafter be described in conjunction with the appended drawings, provided to illustrate and not to limit the present invention, wherein like designations denote like elements, and in which:

FIG. 1 is a schematic representation of an environment, in which various embodiments of the invention may be practiced;

FIG. 2 is a schematic representation of various elements present in a secondary display controller, in accordance with an embodiment of the invention;

FIG. 3 is a flow diagram of a method for saving power consumption while a display device is being refreshed in a computational unit, in accordance with an embodiment of the invention;

FIGS. 4A and 4B comprise a flow diagram of a method for switching the control of a display device from a primary display controller to a secondary display controller, in accordance with an embodiment of the invention;

FIG. 5 is a flow diagram of a method for switching the control of a display device from a secondary display controller to a primary display controller, in accordance with an embodiment of the invention;

FIG. 6 is a flow diagram of a method for activating a secondary display controller from an inactive state, in accordance with an embodiment of the invention;

FIG. 7 is a flow diagram of a method step for converting the data contents of a primary display controller into a reduced bit form, in accordance with an embodiment of the invention;

FIG. 8 is a schematic representation of a method for color-swizzling, in accordance with an embodiment of the invention; and

FIG. 9 is a timing-flow diagram to activate a secondary display controller from an inactive state, in accordance with an embodiment of the invention.

### DETAILED DESCRIPTION OF VARIOUS EMBODIMENTS

The embodiments of the present invention provide a method, system and computer program product for driving a display device in a display subsystem. The display subsystem is present in a computational unit and includes a processor, a primary display controller, a secondary display controller, a frame buffer for the secondary display controller, and the display device. The display device can be driven by either the primary display controller or the secondary display controller. The primary display controller drives the display device when the processor generates new refresh data. In addition, the primary display controller passes on the display data to the secondary display controller. The secondary display controller can either mirror the refresh data and refresh the display device, or can perform manipulations on the refresh data and thereafter refresh the display device. When the processor generates the same refresh data for a predefined time period, the control of the display device is switched from the primary display controller to the secondary display controller. The frame to be displayed is then recorded in the frame buffer of the secondary display controller.

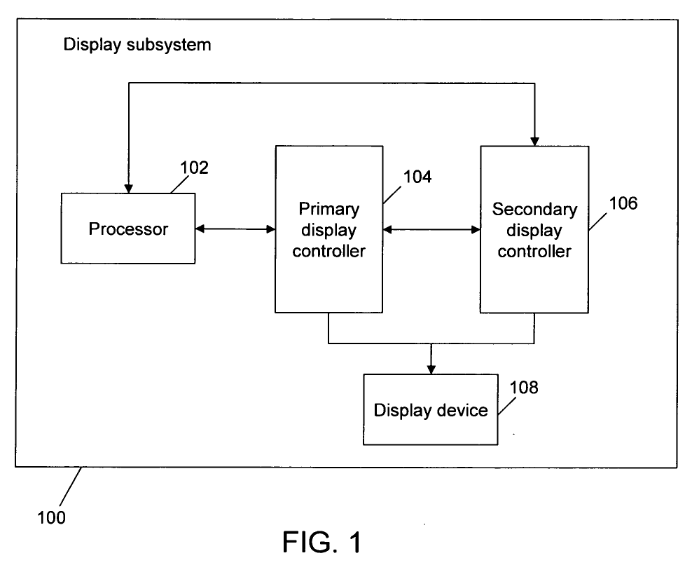

FIG. 1 is a schematic representation of an environment in which various embodiments of the present invention can be practiced. The environment includes a display subsystem 100, which can be present in a computational unit. The computational unit can be, for example, a laptop computer, a palmtop computer, a desktop computer, a calculator, a mobile phone or a Personal Digital Assistant (PDA). Display subsystem 100 includes a processor 102, a primary display controller 104, a secondary display controller 106, and a display device 108. Examples of display device 108 include, but are not limited to, a Liquid Crystal Display (LCD) screen, a Cathode Ray Tube (CRT) monitor, and a plasma screen. Processor 102 is a typical Central Processing Unit (CPU) present in a computational unit. Primary display controller 104 and secondary display controller 106 can be a conventional Video Graphics Array (VGA) or other type of controller or an Application-specific Integrated Controller (ASIC). Processor 102 controls primary display controller 104 and secondary display controller 106.

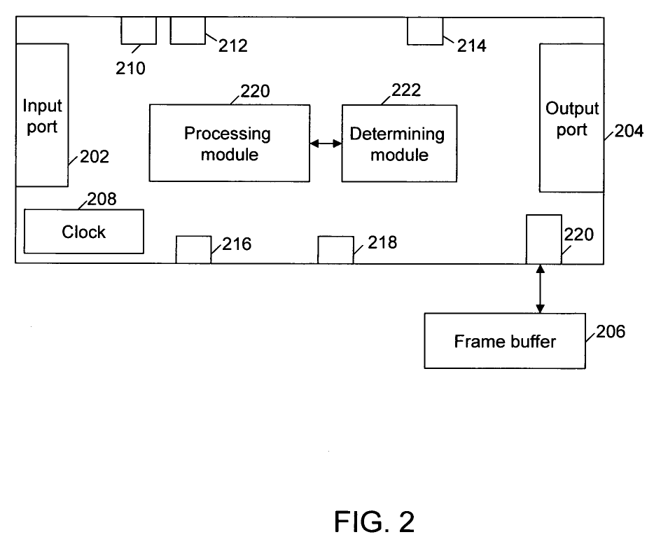

FIG. 2 is a schematic representation of various elements present in secondary display controller 106, in accordance with an embodiment of the invention. Secondary display controller 106 supports various interfaces. The first interface is an input port 202 that is designed to accept refresh data from primary display controller 104.

In accordance with an embodiment of the invention input port 202 is designed to connect directly to a TTL-compatible TFT display controller. This input-only port accepts video data from a conventional VGA controller such as the AMD GX2-533's video display outputs. This interface accepts 19-bits of RGB data in 6-7-6 format, with 6 bits of red, 7 bits of green, and 6 bits of blue data per pixel.

The second interface is an output port 204, which connects directly to a compatible Thin Film Transistor (TFT) panel row, and column driver Integrated Circuits (ICs) that support LCD display output on suitable TFT display devices. The third interface is a Synchronous Dynamic Random Access Memory (SDRAM) interface port 220 that communicates with a low-power synchronous dynamic RAM to store one complete refresh data frame. Secondary display controller 106 autonomously refreshes display device 108 by obtaining refresh data from a frame buffer 206. Frame buffer 206 is associated with secondary display controller 106 and is used to store the refresh data.

In accordance with an embodiment of the invention, Frame buffer 206 is a 512K×16 SDRAM frame buffer containing 1,048,576 bytes, yet the 1200×900 One Laptop Per Child (OLPC) TFT panel, by way of example, contains 1,080,000 pixels. As a consequence, the secondary display controller 106 must perform pixel packing, where each display pixel must occupy less than one byte of memory. The drivers in the panel, and the Double Edged Transistor-Transistor Logic (DETTL) interface, support six bits of information/pixel. Therefore, to improve memory efficiency, each group of four pixels (4 pixels×6 bits/pixel=24 bits) is stored as three bytes in the SDRAM frame buffer (3 bytes*8 bits/byte=24 bits). However, the SDRAM frame buffer is actually 16 bits wide. Consequently, the actual addressable packing of pixels into the frame buffer is that eight pixels (8 pixels*6 bits/pixel=48 bits) are packed into three words (3 words*16 bits/word=48 bits) of SDRAM. With this memory organization, the frame buffer will occupy 405,000 words of the 512K×16 SD-RAM, leaving 119,288 words unused.

In accordance with another embodiment of the invention, frame buffer 206 is included in the secondary display controller 106.

In accordance with yet another embodiment of the invention, frame buffer 206 is external to the frame buffer.

The fourth interface is a clock 208. In accordance with an embodiment of the invention, clock 208 is a directly attached 14.31818 MHz crystal that is supported by an on-chip oscillator, to provide an independent pixel clock for display refresh, regardless of the state of the display input port. Clock 208 also provides the interface timing for attached frame buffer 206. The fifth interface includes one or more input/output pin interfaces that manage timing-critical switching between primary display controller 104 and secondary display controller 106. A first pin 210 determines which of the two display controllers refreshes display device 108. Primary display controller 104 refreshes display device 108 if first pin 210 is in an active state, whereas secondary display controller 106 refreshes display device 108 if first pin 210 is in an inactive state. Further, a second pin 212 is set to an active state if secondary display controller 106 is in an inactive state. A third pin 214 generates one or more interrupts to denote the state of secondary display controller 106. A fourth pin 216 facilitates communication between processor 102 and secondary display controller 102.

In accordance with an embodiment of the invention, secondary display controller 106 includes a fifth pin 218 for driving secondary display controller 106 from an inactive to an active state when processor 102 receives one or more inputs from one or more input devices. These one or more input devices are connected to processor 102.

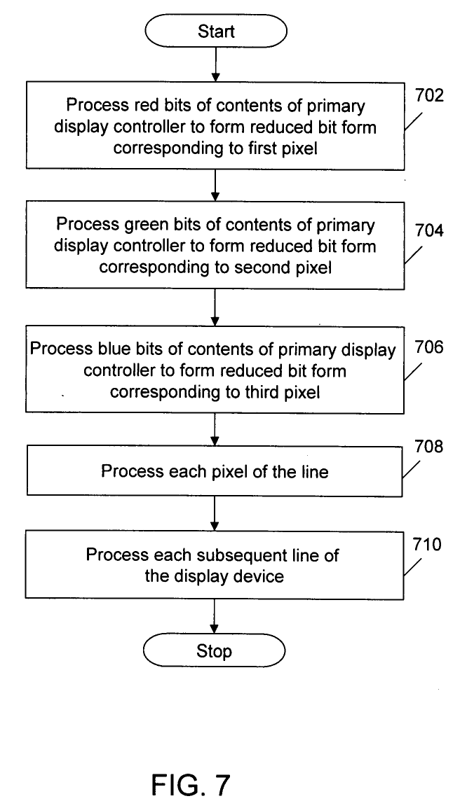

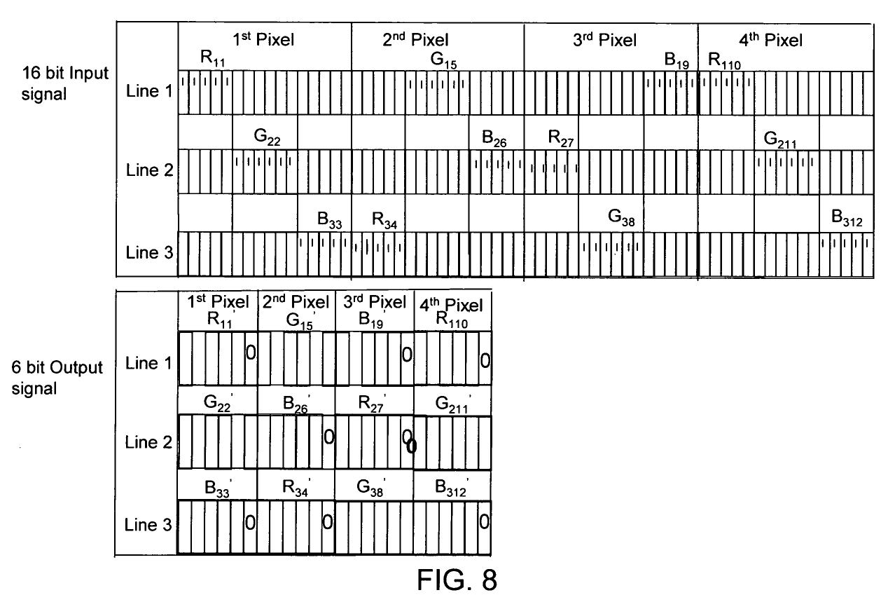

Secondary display controller 106 includes a processing module 220 and a determining module 222. Processing module 220 provides support for color-swizzling, to enable display device 108 to appear as a conventional 24-bit panel. Color-swizzling is the process for converting the data contents of primary display controller 106 to a reduced bit form for better and efficient display. The implementation details of the color-swizzling function are explained in conjunction with the detailed description of FIG. 8. In addition, processing module 220 supports an optional anti-aliasing capability to improve the text display. Processing module 220 provides monochrome mode support for automatic pixel-addressable conversion from color to gray scale. The monochromatic representation matches the human luminosity perception of the refresh data present in primary display controller. This has been explained in detail with conjunction to FIGS. 7 and 8. Determining module 222 assists processing module 220 in anti-aliasing.

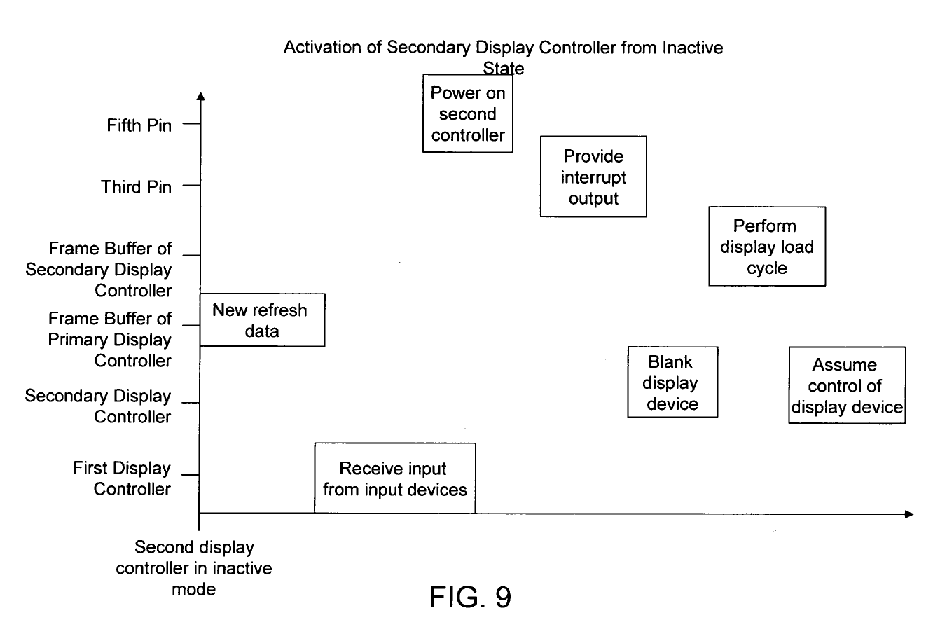

Secondary display controller 106 also has the capability of being transparent to incoming refresh data in the pass-through mode. The pass-through mode can be enabled by altering the value of one or more bits in a register of secondary display controller 106. It thereby emulates a simple LCD timing controller chip and an automatic fly-by mode, to prevent unnecessary writes to attached frame buffer 206. and also minimizes power consumption. Further, secondary display controller 106 includes support for conventional Red Green Blue (RGB) DETTL panels, for efficient debugging, as well as a self-test capability for production-line testing. Details pertaining to the self-test capability for production-line testing have been discussed in detail with conjunction to FIGS. 7 and 9.

In accordance with an embodiment of the invention, a single refresh data frame present in primary display controller 104 is converted to a reduced bit form. This is performed immediately prior to commanding secondary display controller 106 to refresh display device 108. As a result, the efficiency of the display process is enhanced.

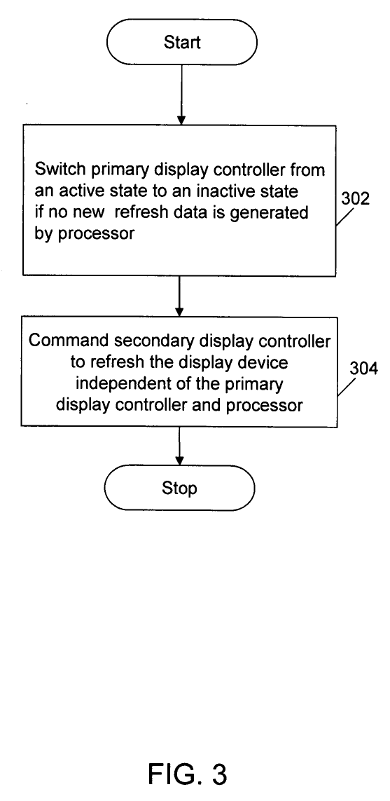

FIG. 3 is a flow diagram of a method for saving power consumption while display device 108 is being refreshed in a computational unit, in accordance with an embodiment of the invention. At step 302, primary display controller 104 is switched from an active to an inactive state if no new refresh data is generated by processor 102. At step 304, secondary display controller 106 is commanded to refresh display device 108, independent of primary display controller 104 and processor 102. Secondary display controller 106 consumes substantially less power than primary display controller 104.

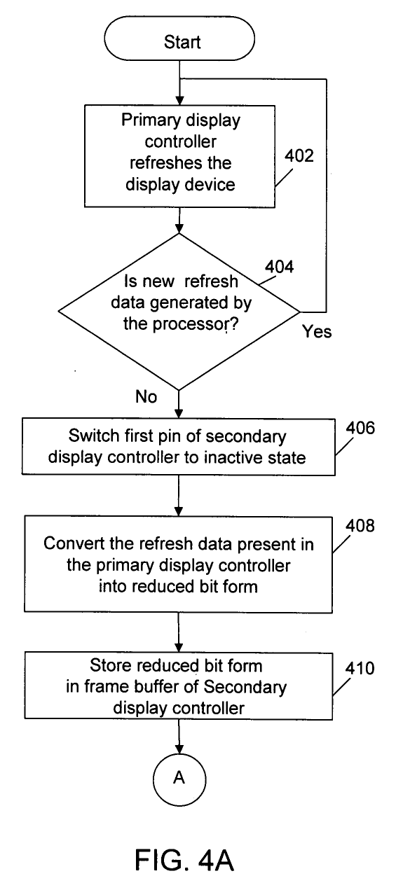

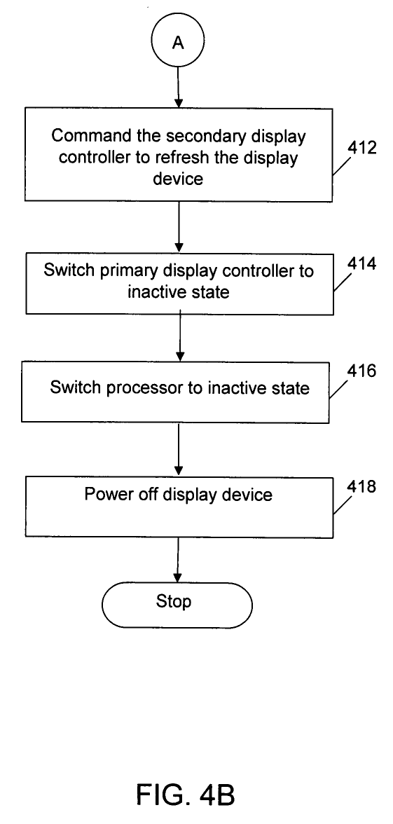

FIGS. 4A and 4B comprise a flowchart of a method for switching the control of display device 108 from primary display controller 104 to secondary display controller 106, in accordance with an embodiment of the invention. At step 402, primary display controller 104 refreshes display device 108 when processor 102 continuously generates new refresh data. At step 404, it is checked whether new refresh data is being generated by processor 102. If processor 102 is generating new refresh data, primary display controller 104 continues to refresh display device 108 at step 402, However, if no new refresh data is being generated by processor 102, first pin 210 of secondary display controller 106 is switched to an inactive state at step 406. Subsequently, refresh data that is present in primary display controller 104 is converted to a reduced bit form at step 408. The reduced bit form is visually indistinguishable from the refresh data present in primary display controller 104. The step of converting the refresh data to a reduced bit form includes one or more modifications being made to the refresh data, such as altering the frequency of the display outputs, or performing color-swizzling or color anti-aliasing functions. At step 410, the reduced bit form is stored in frame buffer 206. At step 412, secondary display controller 106 is commanded to refresh display device 108.

Thereafter, secondary display controller 106 refreshes display device 108 by obtaining the refresh data from frame buffer 204. At step 414, primary display controller 104 is switched to an inactive state from an active state. At step 416, processor 102 is switched to an inactive state. As a result, processor 102 is deactivated after a period of prolonged inactivity. At step 418, display device 108 is powered off if the same refresh data has been displayed for a prolonged period.

In accordance with an embodiment of the present invention, secondary display controller 106 can make modifications to the refresh data and refresh display device 108 without storing the refresh data in frame buffer 204.

In accordance with another embodiment of the present invention, secondary display controller 106 can autonomously assume responsibility for refreshing display device 108 at step 412.

In accordance with an embodiment of the invention, secondary display controller 106 can be switched to an inactive state if it refreshes display device 108 with the same refresh data a predetermined number of times. The value of the number of times after which secondary display controller 106 can be switched to an inactive state is stored in one or more registers in secondary display controller 106.

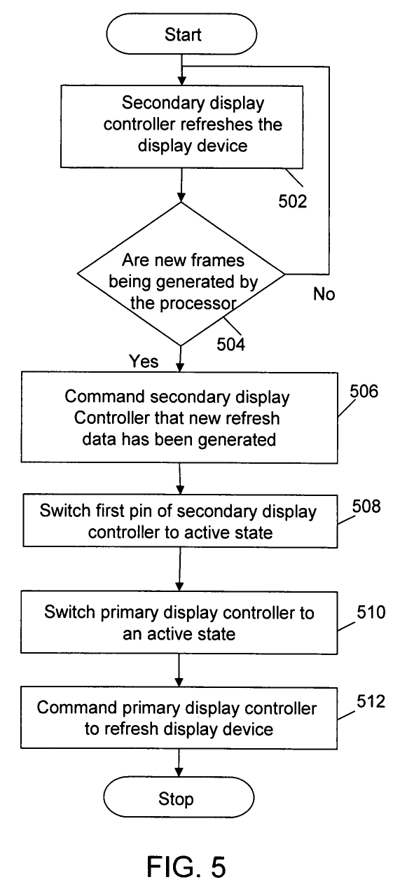

FIG. 5 is a flowchart of a method for switching the control of a display device from a secondary display controller 106 to a primary display controller 104, in accordance with an embodiment of the present invention. At step 502, secondary display controller 106 drives display device 108. At step 504, it is determined whether processor 102 is generating new refresh data. If no new refresh data is generated by processor 102, secondary display controller 106 refreshes display device 108. If new refresh data is being generated by processor 102, secondary display controller 106 is commanded at step 504 that new refresh data has been generated. At step 506, first pin 210 is set to an active state. The active state of first pin 210 indicates the intermediate active recording state of primary display controller 104. At step 510, primary display controller 106 is switched from an active to an inactive state. At step 512, primary display controller 106 is commanded to refresh display device 108. Thereafter, primary display controller 104 passes the refresh data to secondary display controller 106. Secondary display controller 106 can convert the refresh data to a reduced bit form, after which the reduced bit form is used to refresh display device 108.

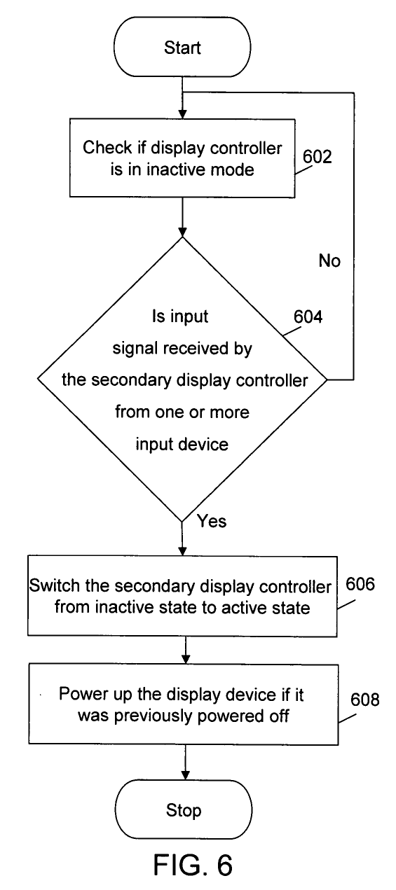

FIG. 6 is a flowchart of a method for activating secondary display controller 106 from an inactive state, in accordance with an embodiment of the present invention. At step 602, it is checked whether secondary display controller 106 is in an inactive state. At step 604, it is determined whether an input signal has been received by secondary display controller 106 from one or more input devices associated with display subsystem 100.

In accordance with an embodiment of the invention, the input signal is received by secondary display controller 106 from one or more input devices without the intervention of processor 102.

In accordance with another embodiment of the invention, the input signal is received by secondary display controller 106 from one or more input devices via processor 102. Examples of the one or more input devices include, but are not limited to, a keyboard, a touchpad, a wireless event, a cursor pad or a mouse.

At step 606, switch secondary display controller 106 is switched from an inactive to an active state. Further, fifth pin 218 is set from an inactive to an active state whenever it receives an input signal from the one or more input devices. If fifth pin 218 is set to an active state when secondary display controller 106 is in an active state, secondary display controller 106 sets one or more registers that store the value of the number of times secondary display controller 106 can be switched to an inactive state.

If processor 102 does not generate new refresh data, secondary display controller 106 starts refreshing display device 108 autonomously with the refresh data present in frame buffer 204. If processor 102 has updated frame buffer 202 with new refresh data, secondary display controller 106 powers up display device 108 and blanks the display by resetting one or more display-blanking registers. Third pin 214 generates an interrupt to instruct secondary display controller 106 to update the refresh data. At step 608, display device 108 is powered up if it was previously powered off.

FIG. 7 is a flow diagram of a method for converting the data contents of the primary display controller to a reduced bit form, in accordance with an embodiment of the invention. The backlight is turned on when secondary display controller 106 is used in a transmissive mode. Each pixel of the reduced bit form represents a single color value—red, blue or green. The Color-swizzling Enable bit, when set to 1, enables secondary display controller 106 to automatically select the proper color field from the input refresh data of the corresponding pixel of the reduced bit form. After the physical panel structure is outlined above at step 702, secondary display controller 106 processes the red input field of the first pixel of the first line of refresh data, to form the first pixel of the first line of the reduced bit form. At step 704, secondary display controller 106 processes the green input field of the second pixel of the first line of refresh data, to form the second pixel of the first line of the reduced bit form.

At step 706, secondary display controller 106 processes the blue input field of the third pixel of the first line of refresh data, to form the third pixel of the first line of the reduced bit form. At step 708, the process is repeated for each pixel in the line. This pattern is repeated across the entire line. At step 710, the process is repeated in each line of the refresh data. However, for each subsequent line in the refresh data, secondary display controller 106 selects pixel colors such that they are offset by one color component in the previous line of the reduced bit form. The first pixel in the second line of the reduced bit form is therefore green, the second pixel in the second line of the reduced bit form is blue, and the third pixel in the second line of the reduced bit form is red. This pattern is repeated across the second line of the reduced bit form. The first pixel in the third line of the reduced bit form is blue, the second pixel in the third line of the reduced bit form is red, and the third pixel in the third line of the reduced bit form is green. This pattern is repeated across the second line. The patterns described above for the first three lines are then repeated in groups of three lines throughout the entire reduced bit form.

In accordance with an embodiment of the present invention, each pixel of the reduced bit form has a single 6-bit value. In accordance with another embodiment of the present invention, red and blue pixels are written with a trailing 0, such that each pixel has a 6-bit left-justified value.

FIG. 8 is a schematic representation of a method for color-swizzling, in accordance with an embodiment of the invention. The figure explains color-swizzling with an example. Color-swizzling is the process for converting the data contents of primary display controller 106 to a reduced bit form. The red bits in the first pixel in line 1 of the 16-bit input signal, referred to as R₁₁, are selected for the first pixel in the first line of the reduced bit, which is referred to as R₁₁′. The green bits in the second pixel in line 1 of the 16-bit input signal, referred to as G₁₅, are selected for the second pixel in the first line of the reduced bit, which is referred to as G₁₅′. The blue bits of the third pixel in line 1 of the 16-bit input signal, referred to as B₁₉, are selected for the third pixel in the first line of the reduced bit, which is referred to as B₁₉′. This pattern is repeated across line 1. Each subsequent line is an offset of the previous line by one color component. The green bits of the first pixel in line 2 of the 16-bit input signal, referred to as G₂₂, are selected for the first pixel in line 2 of the reduced bit form, which is referred to as G₂₂′. The blue bits of the second pixel in line 2 of the 16-bit input signal, referred to as B₂₆, are selected for the second pixel in line 2 of the reduced bit form, which is referred to as B₂₆′. The red bits of the third pixel in line 2 of the 16-bit input signal, referred to as R₂₇, are selected for the third pixel in line 2 of the reduced bit form, which is referred to as R₂₇′. This pattern is repeated across line 2. The blue bits of the first pixel in line 3 of the 16-bit input signal, referred to as B₃₃, are selected for the first pixel in line 3 of the reduced bit form, which is referred to as B₃₃′. The red bits of the second pixel in line 3 of the 16-bit input signal, referred to as R₃₄, are selected for the second pixel in line 3 of the reduced bit form, which is referred to as R₃₄′. The green bits of the third pixel in line 3 of the 16-bit input signal, referred to as G₃₈, are selected for the third pixel in line 3 of the reduced bit, which is referred to as G₃₈′. This pattern is repeated across line 3.

When the color-swizzling mode is enabled, the color anti-aliasing mode bit may be set to 1; The color anti-aliasing mode is said to be active when both the bits are set. In this mode, the color-swizzling process proceeds as described above, but the resulting outputs are filtered to prevent color aliasing. This is particularly important when text fonts are viewed. The filtering process works by combining the current color value of a pixel, for example, with the matching color fields of pixels that are above, below, to the left and to the right of the current pixel. For example, if we consider B₂₆′ in FIG. 8, the pixels that are above, below, to the left and to its right would be the second pixel in line 1, the second pixel in line 3, the first pixel in line 2, respectively, and the third pixel in line 2. The blue bits of these pixels are taken into consideration.

In accordance with another embodiment of the present invention, the input signal comprises 19 bits in a 6-7-6 format, where 6 bits denote a red component, 7 bits a green component, and 6 bits a blue component of input refresh data.

As long as the color-swizzling and the color anti-aliasing bits are 0, secondary display controller 106 may be switched to the monochrome luminance mode by setting the color-anti-aliasing bit to 1. In this mode, the 16-bit input color values in the 5-6-5 RGB format are converted to 6-bit pixel display values via the following simple integer approximation to the standard NTSC luminance-conversion formula and the pixel value=(R>>2)+(R>>4)+(G>>1)+(G>>4)+(B>>3). This works by adding the values of the matching color field from the four neighboring pixels, the neighboring pixels being the pixels above, the pixels below, the pixels to the right and the pixel to the left of the current pixel. After this, the result right 3 bits are shifted and added to the value of the current pixel, which has been shifted right by 1 bit. The resulting output, truncated to 6 bits, is the filtered equivalent of the color-swizzling process when color anti-aliasing has not been enabled. This 6-bit value is stored in frame buffer 204 of secondary display controller 106 of the current pixel.

Please note that when the Color-swizzling Enable bit is 0, secondary display controller 106 simply passes the green component of the refresh data present in primary display controller 104 in another form. Another form is materially-visually identical to the green content of the refresh data present in primary display controller 104. As a result, secondary display controller 106 outputs the green color field value of the input pixel value of each pixel, unless the Monochrome Luminance Enable bit has been set to 1.

In order to ensure minimum power consumption, secondary display controller 106 supports the process of reducing the frequency of the panel interface Dot Clock. The value of this field specifies the crystal oscillator divisor minus one, to yield the system Dot Clock frequency. All the video timings are derived from the Dot Clock. If this field contains 0, the Dot Clock is equal to clock 208 frequency, whereas a value of 7 yields a Dot Clock of ⅛th the crystal frequency. Using a 54.06 MHz crystal, with nominal programmed video-timing parameters that yield a 50-Hz panel refresh rate, and varying the Dot Clock divider alone, results in actual panel refresh rates of 50.00 Hz, 25.00 Hz, 16.67 Hz, 12.50 Hz, 10.00 Hz, 8.33 Hz, 7.14 Hz or 6.25 Hz.

FIG. 9 is a timeline graph of method steps for activating secondary display controller 106 from an inactive state, in accordance with an embodiment of the present invention. The figure describes the states of different elements of display system 200 and the method steps performed by the elements, in chronological order, with the time in x-axis and the system elements in y-axis. Secondary display controller 106 can receive a number of inputs from the input devices. On receiving the inputs, fifth pin 218 powers up secondary display controller 106. Third pin 214 generates an interrupt output after secondary display controller 106 is powered up. Secondary display controller 106 then blanks display device 108. Subsequently, frame buffer 206 performs a display load frame-loading cycle. Secondary display controller 106 assumes control of display device 108 once frame buffer 206 completes the frame-loading cycle.

In light of the explanation given above, industry-based implementation details of the invention (secondary display controller), in accordance with an embodiment, are included herewith. These details include various hardware implementation details including the configuration level details of various processors, ICs, pins, and registers. The explanation will be appreciated by a person who is of ordinary skill in the art and will assist in implementing the invention without undue experimentation.

Secondary Display Controller 106 DIRECT I/O PIN INTERFACE

Some of the interface operations between secondary display controller 106 and processor 104 are time-critical in nature. In particular, switching back and forth between the primary controller 104 managing display refresh and the secondary display controller 106 managing display refresh must be carefully timed, to prevent display artifacts. Secondary display controller 106 uses fast direct I/O pin connections to the CS5536 Companion I/O device in support of these activities. CS5536 is a standard processor for I/O operations designed by Advanced Micro Devices. Details are included on the system interconnections, describing each pin.

The DCONIRQ/pin is the low-active ScanLine Interrupt output from the secondary display controller 106 chip, which may be programmed to be inserted on any specific scanline of the video output. The primary purpose of this pin is to automatically alert the processor 102 at a fixed time, prior to the starting of the next displayed frame. By receiving an interrupt with known timing that is relative to the display operation, the processor 102 can reconfigure the current display state for primary display controller 104—controlled refresh, or secondary display controller 106 controlled refresh, without “busy-wait” or polling loops. See DCONLOAD below for further details.

DCONBLNK is used to provide assistance on occasions when it is desirable to asynchronously initiate a display change in the display state. The secondary display controller 106, which is intended to be polled, will drive the DCONBLNK output under two circumstances. Under the first circumstance, the DCONBLNK output is driven low at the beginning of the first output scan line, following the active Vertical Resolution output scan lines, and remains low until the trailing edge (end) of the output Vsync timing interval, at which point it is driven high again. In the second circumstance, the DCONBLNK output remains high whenever the display of the output of secondary display controller 106 is disabled.

DCONSTAT is used to indicate whether primary display controller 104 or secondary display controller 106 is currently managing managing the display refresh. Since the display control switching of secondary display controller 106 is synchronous with the display process, the status pin allows the processor 102 to identify precisely when the display switching of secondary display controller 106 occurs.

DCONLOAD is used to initiate a Display Load frame-loading cycle. This signal indirectly determines whether the video timing outputs of secondary display controller 106 follow the video inputs or whether the internal timing registers of secondary display controller 106 are driving the video outputs. Please note that in either case the actual data outputs made to the panel will normally be modified by the secondary display controller 106 chip, as discussed in secondary display controller 106 Display Mode register description, above.

Secondary display controller 106 Display Controller ASIC Pinout—2M (1M×16)

DRAM Configuration

Geode Display Interface Pins

Geode Pixel Clock GFDOTCLK 1

Geode Red Data GFRDAT0-4 5

Geode Green Data GFGDAT0-5 6

Geode Blue Data GFBDAT0-4 5

Geode Vsync GFVSYNC 1

Geode Hsync GFHSYNC 1

Geode Display Enable GFDISP_EN 1

Geode FP_LDE GFP_LDE 1

Interface Pins for 1M×16 DRAM

FBRAM Data FBD0-15 16

FBRAM Address FBA0-11 12

FB Column Addr Strobe FBCAS/1

FB Row Addr Strobe FBRAS/1

FBRAM Chip Select FBCS/1

FBRAM Write Enable FBWE/1

FBRAM Clock FBCLK 1

FBRAM Clock Enable FBCLKE 1

Crystal for secondary display controller 106 Self-Refresh

Display XTAL In DCONXI 1

Display XTAL Out DCONXO 1

System Interface Pins

System Reset RESET 1

secondary display controller 106 Interrupt Output DCONIRQ/1

secondary display controller 106 Display Load Command Request DCONLOAD 1

secondary display controller 106 vs. Geode/Display Active Status DCONSTAT 1

secondary display controller 106 Blanking Status DCONBLNK 1

secondary display controller 106 Register I/O SMB Clock DCONSMBCLK 1

secondary display controller 106 Register I/O SMB Data DCONSMBDATA 1

PPTTL/Panel Interface Pins

Panel Pixel Data 1 D1O0-2 3

Panel Pixel Data 2 D2O0-2 3

SCLK SCLK 1

DCLK DCLK 1

GOE GOE 1

GCK GCK 1

GSP GSP 1

DINT DINT 1

SDRESET SDRESET 1

DBC DBC 1

INV INV 1

PWST PWST 1

POL1 POL1 1

POL2 POL2 1

Self-Test/Boundary Scan BIST0-1 2

Total User I/Os 84

### REGISTER DEFINATIONS

Register 0: Secondary Display Controller 106 ID+Revision

This 16-bit register is a read/only-register that returns secondary display controller 106 ASIC identifier and the revision number. The first pass of this silicon should return the hexadecimal value of ‘DC01’H, the next revision should return ‘DC02’H, and so on.

Register 1: Secondary Display Controller 106 Display Mode

Bit 0: Pass-Through Disable

This bit controls whether secondary display controller 106 will perform any manipulation on the refresh data. At power-up, this bit is automatically initialized to 0 by secondary display controller 106, which causes the video outputs to directly follow the video inputs, and secondary display controller 106 is said to be running in the Pass-through mode. In this mode, secondary display controller 106 acts solely as a traditional TFT Timing CONtroller (TCON) chip, where the video outputs are converted only when the are needed to derive DETTL-compatible output signals for the display panel. For power-reduction purposes, SDRAM interface port 220 must be completely disabled while in the Pass-through mode, with not even the SDRAM clock signal being generated. In the Pass-through mode, all other secondary display controller 106 registers and control bits are ignored, except for the Self-test Enable bit, which takes priority over the Pass-through Mode.

Writing a 1 to the Pass-through Disable bit enables normal secondary display controller 106 to function, and includes the activation of SDRAM interface port 220, the internal video timing registers, mode configuration bits, etc.

Bit 1: Secondary Display Controller 106 Sleep Mode

A key factor relating to the power efficiency of secondary display controller 106 is its ability to enter a low-power state in which display device 108 is completely turned off and frame buffer 206 is set to the self-refresh mode. The self-refresh mode is known as the secondary display controller 106 Sleep Mode. Under normal circumstances, secondary display controller 106 automatically enters the Sleep mode as a result of prolonged inactivity of the system, particularly if the Auto Sleep Mode bit is set and the Display Timeout Value video output frames have occurred without a DisplayLoad cycle taking place, or an input signal is received from one or more input devices. Thereafter, secondary display controller 106 is set this bit and enters the Sleep Mode automatically.

Alternatively, there are occasions when processor 102 will need to initiate the switch to the secondary display controller 106 Sleep Mode. In particular, processor 102 should manually enter the Sleep Mode when the power switch selects “System Off”, when the laptop lid switch is closed, or when a critically low battery level is detected. To enter the Sleep Mode, this bit should be written with a ‘1’.

Since frame buffer 206 is held in the low-power self-refresh state while secondary display controller 106 is in the Sleep Mode, secondary display controller 106 is unable to process incoming Display Load cycles. However, the load pin of the secondary display controller 106 is not ignored. If processor 102 makes a request for a DisplayLoad cycle while secondary display controller 106 is in the Sleep Mode, an internal state, known as secondary display controller 106 LOAD_MISSED, is set. This state is used to inform secondary display controller 106 that the data in frame buffer 206 is no longer consistent with the latest refresh data generated by processor 102. When secondary display controller 106 exits sleep mode after missing secondary display controller 106 load, it will automatically blank display device 108, and will generate a secondary display controller 106 LOAD_MISSED interrupt by driving secondary display controller 106 IRQ active for one line of refresh data. This allows processor 102 to rewrite the latest refresh data generated by processor 102, and then to clear the Video Blanking pin to paint the newest information on display device 108.

The process of exiting the Sleep Mode can be performed either manually or automatically. Under normal circumstances, this bit is cleared automatically on the arrival of an ECPWRRQST. An ECPWRRQST arrives when secondary display controller 106 receives an input signal from one or more input devices. In other words, pressing a key restores the video display, independent of processor 102, thereby “instantly” turning on display device 198 when a keyboard key, a cursor button or the touchpad has been activated. Alternatively, processor 102 may exit the Sleep Mode, if required, and reinitiate the process of refreshing display device 108 by clearing this bit to 0.

Bit 2: Auto Sleep Mode

When this bit is set to 1, secondary display controller 106 automatically stops the display process after Display Timeout Value video frames have been output without system activity. Any time secondary display controller 106 LOAD is high, or when an incoming ECPWRRQST occurs, the internal display timeout register is automatically reset to the value in the display timeout value register. If a display timeout occurs, secondary display controller 106 automatically enters the Sleep Mode by setting the secondary display controller 106 Sleep Mode bit to 1. When the auto Sleep Mode bit is 0, secondary display controller 106 continues to refresh display device 108 indefinitely. If the Display Load cycles or ECPWRRQST occurs, the Sleep Mode may only be entered by writing to the secondary display controller 106 Sleep Mode bit.

Bit 3: Backlight Enable

Backlight enable is used to determine whether the backlight of display device 108 should be turned on while the display is enabled. This bit is set to 1 to turn on the backlight whenever secondary display controller 106 is not in the secondary display controller 106 Sleep Mode. Please note that it is not necessary for a screensaver to turn the Backlight Enable on and off, since setting this bit allows the backlight to be enabled and disabled automatically. If this bit is left cleared, the backlight remains disabled, whether the secondary display controller 106 is in the secondary display controller 106 Sleep mode or not. When the Backlight is enabled, the BACKLIGHT pin is actively driven high and the DBC pin is driven with a PWM waveform, with a duty cycle that matches the value of the Backlight Brightness register.

Bit 4: Video Blanking

Video blanking is used to display “black” on the screen without affecting the contents of secondary display controller 106 frame buffer 206, or the power state of display device 108. This feature is primarily used to determine whether secondary display controller 106 should exit the Sleep Mode with display device 108 displaying refresh data, or with display device 108 masked off until the next DisplayLoad cycle. This is notably used by secondary display controller 106. Since secondary display controller 106 cannot record incoming DisplayLoad cycles while in the Sleep Mode, it will automatically set the VIDEO_BLANKING bit if secondary display controller 106 LOAD goes high while sleeping. This ensures that old refresh data is not displayed on wakeup. If this bit is written with a ‘1’, display device 108 displays “black”. If written with ‘0’, the current contents of frame buffer 206 is displayed on display device 108.

Bit 5: Color-Swizzling Enable

In accordance with an embodiment of the invention, display device 108 selected is a hybrid monochrome/color panel that does not utilize conventional RGB sub-pixels. Instead, each pixel contains only a single “sub-pixel value”. When used as a reflective panel, i.e., when the backlight is off, these pixel values represent gray scales. The resulting image is a monochrome display. When used in the transmissive mode, i.e., when the backlight is on, each pixel represents a single color value from the set of red, green and blue.

The first pixel of the first line of refresh data is red, the second pixel of this line is green, and the third pixel is blue. This pattern repeats across the line. Please note, however, that each subsequent line is offset from the prior line by one color component. The first pixel of the second line is therefore green, its second pixel is blue, and its third pixel is red. This pattern is repeated across the second line. The first pixel of the third line is blue, its second pixel is red, and its third pixel is green This pattern is repeated across the third line. The patterns described above for the first three lines are then repeated in groups of three lines throughout the entire display panel.

This color pattern helps to eliminate display artifacts, but it also complicates system software. The Color-swizzling Enable bit, when set to 1, enables secondary display controller 106 to automatically select the proper color field from the input 6-7-6 refresh data. Following the physical panel structure outlined above, secondary display controller 106 selects the red input field for the first pixel on the first line, the green input field for the next pixel on this line, and so on. The net effect of the Color-swizzling Enable function is that secondary display controller 106 automatically discards two-thirds of the input refresh data, with the result that each output pixel that is written to frame buffer 206 has a single 6-bit value.

Please note that when the Color-swizzling Enable bit is 0, secondary display controller 106 simply outputs the six most significant bits of the green color field of each input pixel, unless the Monochrome Luminance Enable bit is set to 1. The Color-swizzling Mode alone does not require the use of secondary display controller 106 scan-line ring buffers, described below; only the Color Anti-aliasing Mode, active when both the Color-swizzling and Color Anti-aliasing Mode bits are set to 1, requires the use of the ring buffers of the chip.

Whenever the Color Swizzling mode is active, the secondary display controller 106 COLMODE output pin is driven high. This pin enables display device 108 to switch its internal panel bias to optimize the display quality in either the Color or Monochrome Mode.

Bit 6: Color Anti-Aliasing Enable

When the Color-swizzling Mode is enabled, the Color Anti-aliasing Mode bit may also be set to 1. When both the bits are set, the Color Anti-aliasing Mode is said to be active. In this mode, the Color-swizzling process proceeds as described above, but the resulting outputs are filtered to prevent Color Aliasing. This filtering process works by combining the color value of the current pixel at the pixel coordinate (V, H) with the matching color fields from the pixels that are above (V−1, H), below (V+1, H), to the left (V, H−1), and to the right (V, H+1) of the current pixel. The procedure works by adding up the values of the matching color field from these four neighboring pixels, shifting the result right 3 bits, and adding it to the current value of the pixel, shifted right by one bit. The resulting output, truncated to six bits, is the filtered equivalent of the Color-swizzling process when Color Anti-aliasing is not enabled—this six-bit value is stored in frame buffer 206 of the current pixel.

It is particularly important to emphasize that the Color Anti-aliasing process works with 19-bit color values, not with the 6-bit color values that are the output of the Color-swizzling process when Color Anti-aliasing is not enabled. The math described above is computed specifically on the color fields that are appropriate for the current pixel. In other words, if the current pixel has a red color filter, the math adds up and combines the red fields of the neighboring pixels with the red field of the current pixel. The next pixel to the right performs the same function on the green color fields of the current and neighboring pixels, etc.

In order to obtain the proper color fields for Color Anti-aliasing, two consequences are immediately obvious. First, it is necessary to utilize a two-scan line-long ring buffer to perform this processing. Second, each element of the ring buffer must hold 19 bits of color data in the 6-7-6 input color format rather than in the 6-bit output format.

Implementation details: The input-line buffers are typically 2×1200 19-bit words. However, once the buffers are implemented, it is vital that they are updated on a per-pixel basis, in the same manner as a ring buffer. Otherwise, three full scan lines are required to perform the Color Anti-aliasing function.

Implementation Warning: The simplified math given above is used for ease of understanding, not to convey the actual implementation. For example, the use of right-shift operators, above, is intended to specify the alignment of the bits to different color components, not to imply that any bits are “lost” during the Anti-aliasing process. For visual display quality, it is imperative that full 10-bit precision is maintained until the complete result is output. Only the final output of the Anti-aliasing process can be truncated to six bits by discarding the four LSBs. Implementations that discard the least significant bits during Anti-aliasing computation, prior to output truncation, are not accepted.

Bit 7: Monochrome Luminance Enable

As long as the Color Swizzling and Color Anti-aliasing bits are 0, secondary display controller 106 may be placed in the Monochrome Luminance mode by writing this bit to 1. In this mode, 19-bit input color values, again in the 6-7-6 RGB format, are converted into 6-bit pixel display values via the following simple integer approximation to the standard NTSC luminance conversion formula:
Pixel Value=(R>>2)+(R>>4)+(G>>1)+(G>>4)+(B>>3)

Please note that unlike in the Color Anti-aliasing mode, the Monochrome Luminance function works solely on the color fields of the current pixel. As a result, the on-chip 2-line ring buffer is not used in this mode.

Implementation Warning: The simplified math given above is used for ease of understanding, not to convey the actual implementation.

Bit 8: Scan Line Interrupt Enable

Setting this bit to 1 enables the output of the secondary display controller 106 Scan Line Interrupt to be generated during the video scan line that is programmed into the Scan Line Interrupt Value register. This interrupt becomes active at the start of the programmed scan line, and remains active for one scan line duration in each frame. This sequence continues as long as the Scan Line Interrupt Enable bit is 1.

Bits 9-11: Dot Clock Divider

In order to support minimum power drain, secondary display controller 106 supports the ability to reduce the frequency of the panel interface Dot Clock. The value in this field specifies the crystal oscillator divisor minus one, to yield the system Dot Clock frequency—all video timings are derived from the Dot Clock. If this field contains 0, the Dot Clock is equal to the clock frequency of the crystal, whereas a value of 7 yields a Dot Clock of one-eighth the crystal frequency. Using 4×, the 14.31818 MHz crystal, with nominal programmed video timing parameters that yield a 50 Hz panel refresh rate, and varying the Dot Clock divider alone, results in actual panel refresh rates of 50.00 Hz, 25.00 Hz, 16.67 Hz, 12.50 Hz, 10.00 Hz, 8.33 Hz, 7.14 Hz, or 6.25 Hz.

Bit 12-13: Reserved

These Read-only bits are reserved.

Bit 14: Debug Mode Enable

When the Debug Mode bit is written high, two actions occur. First, the LCD panel interface changes to support a conventional color LCD with color subpixels. Second, SDRAM interface port 220 changes to support 4 MB of SDRAM. On the production of secondary display controller 106 ASICs, this bit should remain cleared to 0.

Bit 15: Self-Test Mode

At power-up, secondary display controller 106 samples the BIST pin to determine whether it should enter normal operation—BIST Low or self-test operation—BIST High. The state of the BIST pin is copied to the Self-test Mode bit on exiting reset. Software may also initiate entry into the BIST Mode by writing this bit with a 1, and can restore normal operation by writing this bit with a 0. When secondary display controller 106 is placed in the Self-test Mode, and no input video clock has been detected, secondary display controller 106 automatically cycles its display outputs through the sequences white, black, red, green and blue every two seconds.

Register 2: Horizontal Resolution

This 16-bit register contains the number of displayed pixels per horizontal line, which is normally 1200. Please note that due to timing constraints in primary display controller 104. secondary display controller 106 may receive more input pixel clocks than the number programmed in this register. When this occurs, subsequent clocks, beyond the number of pixels programmed in this register, should be ignored until the next HSync pulse has occurred. Consequently, the number programmed in this register should match the memory pitch, after pixel packing, from one line to the next, as stored in frame buffer 206

Register 3: Horizontal Total

This 16-bit register contains the total number of dot clocks per horizontal scan line.

Register 4: Horizontal Sync Start and Width

This 16-bit register contains two 8-bit registers. The most significant byte of the register contains the Horizontal Sync Start register. After “Horizontal Resolution”, dot clocks occur on each line. HSync is generated after “HSync Start” additional clocks have occurred. The least significant byte in this register contains the number of clocks so that HSync remains active once HSync has been generated.

Register 5: Vertical Resolution

This 16-bit register contains the total number of lines to be displayed per video frame. This normally contains the value 900.

Register 6: Vertical Total

This 16-bit register contains the total number of scan-line durations that occur per video frame. For clarity, the TFT panel refresh rate in Hz is equal to the value in the register.
Dot Clock/(Horizontal Total*Vertical Total)
Register 7: Vertical Sync Start and Width

This 16-bit register contains two 8-bit registers. The most significant byte in the register contains the vertical sync start register. After Vertical Resolution lines are displayed, VSync is generated after “VSync Start” additional number of times the scan-line has occurred. The least significant byte in this register contains the number of scan lines that VSync should remain active, once VSync has been generated.

Register 8: Display Timeout Value

In order to save power, secondary display controller 106 has the capability of automatically powering down the display outputs and entering the secondary display controller 106 Sleep Mode. This register contains the number of output video frames before automatic power down occurs.

Register 9: Scan Line Interrupt Value

In order to synchronize processor 102 video output with secondary display controller 106 video output properly, secondary display controller 106 has the ability to enable systems software to synchronize with the display process by generating a processor 102 interrupt at any given line of the display. This register is written with the output video scan-line number during which the interrupt should be generated.

Register 10: Backlight Brightness

Only the upper four bits of this register are used—the lower 12 bits are undefined and should be ignored. The Backlight Brightness register is used to set the duty cycle of the DBC output pin. The value of 00H corresponds to a duty cycle of 0 percent, while the value of 0FH corresponds to a duty cycle of 100 percent. Interim values may be used to set specific brightness levels. Please note that the DBC pin can only be driven with a PWM waveform if the Backlight Enable bit is set to 1 and the panel is currently enabled.

Registers 11-127: Reserved

These registers are reserved.

In light of the above, the industry-based implementation details of the invention (secondary display controller Version 0.8), in accordance with another embodiment, areincluded herewith.

Secondary Display Controller 106 DIRECT I/O PIN INTERFACE

Some of the interface operations between secondary display controller 106 and processor 102 are time-critical in nature. In particular, switching between the primary display controller 104 managing display refresh and the secondary display controller 106 managing display refresh must be carefully timed to prevent display artifacts. In support of these activities, secondary display controller 106 uses fast direct I/O pin connections to the CS5536 Companion I/O device. Details of the interconnections in the system follow in the description of each pin.

DCONBLNK-CS5536 GPIO12

DCONBLNK is used to assist processor 102 to synchronize its video timing with the timing of the secondary display controller 106 video, to ensure a trouble-free transition from secondary display controller 106-controlled refresh to processor 102-controlled refresh. Intended to be polled, secondary display controller 106 drives the DCONBLNK output in two circumstances. In the first, the DCONBLNK output is driven low at the beginning of the first output scan line following the active Vertical Resolution output scan lines, and remains low until the trailing edge (end) of the output VSync timing interval, at which point it is driven high again. In the second, the DCONBLNK output remains high whenever secondary display controller 106 is in the secondary display controller 106 Sleep Mode.

DCONLOAD-CS5536GPIO11

DCONLOAD controls the source of the refresh cycles of the video display. This signal indirectly determines whether the video-timing outputs of secondary display controller 106 follow the video inputs, indicating that primary display controller 104 controller is managing display refresh, or whether the internal timing registers of secondary display controller 106 are driving the video outputs. Please note that in either case, the actual data output to the panel is normally modified by the secondary display controller 106 chip, as discussed in the secondary display controller 106 Display Mode register description. The exception to this is when secondary display controller 106 is running in the Pass-through Mode, in which case the data output of secondary display controller 106 simply reflects a six-bit truncation of the green video data input, as suitably delayed for proper signal phasing.

DCONIRQ/-CS5536 INTB#

The DCONIRQ/pin is the low-active Interrupt Request output from the secondary display controller 106 chip. This signal is driven under three circumstances. First, on the completion of a DisplayLoad cycle, DCONIRQ/ is driven to inform processor 102 that it is now safe to disable primary display controller 104. In addition, secondary display controller 106 may be programmed to generate an interrupt on any specific scan line of the video output. The primary purpose of this usage is to automatically alert processor 102 at a fixed time, prior to the start of the next displayed frame. When receiving an interrupt with known timing that is relative to the display operation, processor 102 can restart its video in sync with the current display of secondary display controller 106, without display artifacts. The scan-line interrupt capability can also be used for conventional purposes such as display animation.

The final DCONIRQ interrupt source occurs when processor 102 has updated the screen and performed a DisplayLoad sequence, but secondary display controller 106 was in the Sleep Mode at that time. When secondary display controller 106 is later woken up by ECPWRRQST, it normally powers up the panel and restarts display refresh autonomously. However, in this case, secondary display controller 106 powers up the panel instead, holding its video in a blanked state by setting the Video Blanking bit, and generates a DCONLOAD_MISSED interrupt, to inform processor 102 that it must update the display. Please note that it is the responsibility of processor 102 to clear the Video Blanking bit after updating the display. (Writing to the Video Blanking bit clears the internal DCONLOAD_MISSED status flag.)

DCONSTAT0 . . . 1-CS5536 GPIO5 & GPIO6

DCONSTAT pins are used to communicate the fast status to processor 102. specifically for the purpose of identifying the cause behind a DCONIRQ interrupt. DCONSTAT0 . . . 1 pins are encoded as follows:

00: A scan-line interrupt occurred while processor 102 was controlling refresh, i.e., the Full-on Mode. This status is used to indicate that any interrupts that arrive are conventional scan-line interrupts, i.e., those associated with animation, etc.

01: A scan-line interrupt occurred in State 2 (secondary display controller 106 Mode). This status is used in conjunction with the re-initialization of processor 102 video outputs, to initiate synchronization of the video timings of processor 102 with the video timings of secondary display controller 106. Following this interrupt, it is expected that processor 102 will poll the DCONBLNK pin to perform fine timing synchronization.

10: A DisplayLoad completed interrupt occurred. This status informs processor 102 that secondary display controller 106 has finished recording a video frame, and that it is therefore safe for processor 102 to disable the clocks of the on-chip primary display controller 104 controller and outputs for maximum power saving.

11: A DCONLOAD_MISSED interrupt occurred while exiting from the Sleep Mode. As mentioned earlier, if processor 102 draws to the screen while secondary display controller 106 is in the Sleep Mode, the screen is out of date on waking up. This interrupt signals to secondary display controller 106 that it must perform a DisplayLoad cycle and then clear the Video Blanking bit in the secondary display controller 106 mode register, to enable the display.

This encoding may seem a little obscure, but it is a reflection of the need to put in the maximum status information into the available pin out.

ECPWRRQST—System Activity Monitor

The ECPWRRQST pin is used to “wake up” secondary display controller 106 from the Sleep Mode. Whenever a keyboard, touchpad or cursor key event occurs, the embedded controller in the system pulses this pin high. The rising edge of ECPWRRQST causes secondary display controller 106 to automatically power up the display and initiate display refresh autonomously (see the description given above of the DCONLOAD_MISSED interrupt of an important exception). If secondary display controller 106 has entered the Sleep Mode, either automatically or manually, it remains in the Sleep Mode until the Sleep Mode bit of secondary display controller 106 is cleared to 0 or the ECPWRRQST pin is toggled high, which clears the secondary display controller 106 Sleep Mode bit.

Please note that ECPWRRQST arriving while the display is active has only one effect—it resets the internal Display Timeout register to the value in the Display Timeout Value register.

The minimum duty cycle of ECPWRRQST active is ˜100 nS. (This pin need not be debounced or filtered.)

Secondary display controller 106 REGISTER DEFINITIONS

| REGISTER | INDEX | DEFAULT |
|---|---|---|
| secondary display | 106 ID & | DC01H |
| controller | Revision 0 | |
| secondary display | 106 Display | 0012H |
| controller | Mode 1 | |
| Horizontal Resolution | 2 | 0458H (1200 Decimal) |
| Horizontal Total | 3 | 04E8H (1256 Decimal) |
| Horizontal Sync | 4 | 1808H (24, 8 Decimal) |
| Vertical Resolution | 5 | 0340H (900 Decimal) |
| Vertical Total | 6 | 0390H (912 Decimal) |
| Vertical Sync | 7 | 0403H (4, 3 Decimal) |
| Display Timeout | 8 | FFFFH |
| Scanline Interrupt | 9 | 0000H |
| Backlight Brightness | 10 | XXXFH |
| Reserved | 11-127 | |

Secondary display controller 106 USER I/O PIN DEFINITIONS
secondary display controller 106 ASIC Pinout—1M (512K×16) SDRAM Configuration

Geode Display Interface Pins

| | | |
|---|---|---|
| Geode Pixel Clock | GFDOTCLK | 1 |
| Geode Red Data | GFRDATO-5 | 6 |
| Geode Green Data | GFGDATO-6 | 7 |
| Geode Blue Data | GFBDATO-5 | 6 |
| Geode VSync | GFVSYNC | 1 |
| Geode HSync | GFHSYNC | 1 |
| Geode FP_LDE | GFP_LDE | 1 |

Interface Pins for 512K×16 SDRAM

| | | |
|---|---|---|
| FBRAM Data | FBD0-15 | 16 |
| FBRAM Address | FBDA0-10 | 11 |
| FB Column Addr Strobe | FBCAS/ | 1 |
| FB Row Addr Strobe | FBRAS/ | 1 |
| FB Data Masks | FBDM0-1 | 2 |
| FBRAM Chip Select | FBCS/ | 1 |
| FBRAM Write Enable | FBWE/ | 1 |
| FBRAM Clock | FBCLK | 1 |
| FBRAM Clock Enable | FBCLKE | 1 |

Crystal for secondary display controller 106 Self-Refresh

| | | |
|---|---|---|
| Display XTAL In | DCONXI | 1 |
| Display XTAL Out | DCONXO | 1 |

System Interface Pins

| | | |
|---|---|---|
| System Reset | RESET | 1 |
| EC Power On Request | ECPWRRQST | 1 |
| secondary display | | |
| controller 106 | | |
| Interrupt Output | DCONIRQ/ | 1 |
| secondary display | | |
| controller 106 | | |
| Display Load | DCONLOAD | 1 |
| Command Request | | |
| secondary display | | |
| controller 106 | | |
| Status Pins | DCONSTAT | 2 |
| secondary display | | |
| controller 106 | | |
| Blanking Status | DCONBLNK | 1 |
| secondary display | | |
| controller 106 | | |
| Register I/O | DCONSMBCLK | 1 |
| SMB Clock | | |
| secondary display | | |
| controller 106 | | |
| Register I/O | DCONSMBDATA | 1 |
| SMB Data | | |

DETTL/Panel Interface Pins

| | | |
|---|---|---|
| Panel Pixel Data 0 | DO00-DO01 | 3 |
| Panel Pixel Data 1 | DO10-DO11 | 3 |
| Panel Pixel Data 2 | DO20-DO21 | 3 |
| Source Dot Clock | SCLK | 1 |
| Data Interface | REV1-2 | 2 |
| Polarity Control | | |
| Graphics Output Enable | GOE | 1 |
| (Gate driver enable) | | |
| ??? | INV | 1 |
| ??? | CPV | 1 |
| ??? | STV | 1 |
| ??? | FSTH | 1 |
| ??? | BSTH | 1 |
| ??? | TP | 1 |
| LCD Backlight Enable | BACKLIGHT | 1 |
| Display Backlight | DBC | 1 |
| Control (PWM) | | |
| Driver Polarity | POL1 | 1 |
| Signal 1 | | |
| LCD VDD Enable | VDDEN | 1 |
| Burn-In/Test Mode | AGMODE | 1 |
| Color/Monochrome | COLMODE | 1 |
| Panel Bias Select | | |
| Total User I/Os | | 94 |

Secondary display controller 106 REGISTER DEFINITIONS

The primary programming interface to secondary display controller 106 chip is a 100 KHz serial SMBUS interface, which allows read and write access to the internal configuration registers of the chip. These registers are all 16-bits in length and access is only supported as 16-bit registers. Accessing these registers in any other mode is undefined and may yield unpredictable results. Specifically, 32-bit SMBUS cycles are used to communicate with secondary display controller 106 properly, the first eight bits specifying the SMBUS address that is always ODH in this implementation as well as in the ReadNVrite Mode bit. The next eight bits supply the register number that is to be communicated with, and the remaining 16 bits contain the contents of the desired register. To understand the communication of secondary display controller 106 with the system, please note that secondary display controller 106 is connected to the SMBUS port of the AMD CS5536 I/O chip at the SMBUS address 0DH.

Register 0: Secondary Display Controller 106 ID+revision This 16-bit register is a read/only register, which returns the secondary display controller 106 ASIC identifier, and revision number. The first pass of this silicon should return a hexadecimal value of ‘DC01’H, the next revision should return ‘DC02’H, and so on.

Register 1: Secondary Display Controller 106 Display Mode

Bit 0: Pass-Through Disable

This bit controls whether secondary display controller 106 will perform any manipulation on the refresh data. At power-up, this bit is automatically initialized to 0 by secondary display controller 106, which causes the video outputs to follow the video inputs directly, and secondary display controller 106 is said to be running in the Pass-Through Mode. In this mode, secondary display controller 106 acts solely as a traditional TFT Timing CONtroller (TCON) chip, where video outputs are converted only when they are needed to derive DETTL-compatible output signals for the display panel. For power-reduction purposes, SDRAM interface port 220 must be completely disabled while in the Pass-Through Mode, where not even the SDRAM clock signal is generated. In the Pass-through Mode, all other secondary display controller 106 registers and control bits are ignored, except for the Self-test Enable bit, which takes priority over the Pass-through Mode.

Writing a 1 to the Pass-through Disable bit enables normal secondary display controller 106 to function, and includes the activation of SDRAM interface port 220 as well as that of the internal video timing registers, mode-configuration bits, etc.

Bit 1: Secondary Display Controller 106 Display Enable

The Display Enable bit is initialized to 1 on the completion of the reset process by secondary display controller 106. This normal state allows the outputs of the secondary display controller 106 panel interface to be driven, as defined by the current chip mode. Writing this bit to 0 immediately and asynchronously drives the video outputs to a low-power blanked state. Subsequently, setting this bit enables video outputs, but the re-enabling process is synchronous—the panel drivers remain in a low power state until the trailing edge of the next Vsync output-timing interval. At that point, the video drivers turn on and remain on until the secondary display controller 106. Display Enable, is once again cleared.

Please note that secondary display controller 106 clears this bit automatically, and the display is blanked,

If the Display Timeout Enable bit is set, Display Timeout Value video output frames have occurred without a DisplayLoad cycle occurring.

Bit 2: Color-Swizzling Enable

In accordance with an embodiment of the invention, the selected display device 108 is a hybrid monochrome/color panel that does not utilize conventional RGB sub-pixels. Instead, each pixel contains only a single “sub-pixel value”. When used as a reflective panel, when the backlight is disabled, these pixel values represent grey scales, and the resulting image is a monochrome display. When used in the transmissive mode, when the backlight is turned on, each pixel represents a single color value from the set of red, green and blue}.

The first pixel of the first line of refresh data is red, the second pixel green and the third pixel blue. This pattern is repeated across the line. Please note, however, that each subsequent line is offset from the prior line by one color component. The first pixel of the second line is therefore green, its second pixel blue, and its third pixel red. This pattern is repeated across the second line. The first pixel of the third line is blue, the second pixel red, and the third pixel green. The pattern of the first pixel is repeated across the third line. The patterns described above for the first three lines are then repeated in groups of three lines throughout the entire display panel.

This color pattern helps to eliminate display artifacts but also complicates the system software. The Color-swizzling Enable bit, when set to 1, enables secondary display controller 106 to automatically select the proper color field from the input 6-7-6 refresh data. Following the physical panel structure outlined above, secondary display controller 106 selects the red input field for the first pixel on the first line, the green input field for the next pixel on this line, and so on. The net effect of the Color-swizzling Enable function is that secondary display controller 106 automatically discards two-thirds of the input refresh data, with the result that each output pixel that is written to frame buffer 206 has a single 6-bit value.

Please note that when the Color-swizzling Enable bit is 0, secondary display controller 106 simply outputs the value green color field value of the input pixel to each pixel, unless the Monochrome Luminance Enable bit is set to 1. Please note that the Color-swizzling Mode, on its own, does not require the use of secondary display controller 106 scan-line ring buffers, since it is only in the Color Anti-aliasing Mode that the Color-swizzling as well as the Color Anti-aliasing Mode bits are active and require the use of the ring buffers of the chip.

Bit 3: Color Anti-Aliasing Enable

When the Color-swizzling Mode is enabled, the Color Anti-aliasing Mode bit can also be set to 1. When both the bits are set, the Color Anti-aliasing Mode is said to be active. In this mode, the Color-swizzling process proceeds as described above, but the resulting outputs are filtered to prevent color aliasing. This filtering process works by combining the color value of the current pixel at pixel coordinate (V, H) with the matching color fields from the pixels that are above (V−1, H), below (V+1, H), to the left (V, H−1), and to the right (V, H+1) of the current pixel. This involves adding the values of the matching color field to those of the four neighboring pixels, shifting the result right by 3 bits, and adding it to the value of the current pixel, shifted right by one bit. The resulting output, truncated to six bits, is the filtered equivalent of the Color-swizzling process when Color Anti-aliasing is not enabled. This six-bit value is stored in frame buffer 206 of the current pixel.

It is particularly important to emphasize that the Color Anti-aliasing process works with 16-bit color values, and not with 6-bit color values that are the output of the Color-swizzling process when Color Anti-aliasing is not enabled. The math described above is computed specifically on those color fields that are appropriate for the current pixel. In other words, if the current pixel has a red color filter, the math adds up and combines the red fields of the neighboring pixels with that of the current pixel. The next pixel, to the right, performs the same function on the green color fields of the current and neighboring pixels, etc.

In order to obtain the proper color fields for Color Anti-aliasing, two facts are immediately obvious. First, it is necessary to utilize a two-scan line-long ring buffer to perform processing. Second, each element of the ring buffer must hold 16 bits of color data in the 5-6-5 input color format rather than the 6-bit output format.

Implementation Details: Input line buffers are typically either 2×1110-word long or 2×830-word long, depending on whether the display is being driven in the portrait or the landscape mode. However, once the buffers are implemented, it is vital that they are updated on a per-pixel ring-buffer basis. Otherwise, three full scan lines are required to perform the Color Anti-aliasing function.

Implementation Warning: The simplified math given above is used for ease of understanding, not to convey the actual implementation. For example, the use of left-shift and right-shift operators is intended to specify the alignment of the bits from different color components, not to imply that any bits are “lost” during the Anti-aliasing process. To achieve visual display quality, it is imperative that full 10-bit precision is maintained until the complete result is output. Only the final output of the Anti-aliasing process can be truncated to six bits.

Implementations that discard the least significant bits during Anti-aliasing computation, prior to the output truncation, are not accepted.

Bit 4: Monochrome Luminance Enable

As long as the Color-swizzling and Color Anti-aliasing bits are 0, secondary display controller 106 may be placed in the Monochrome Luminance Mode by writing this bit to 1. In this mode, 16-bit input color values in 5-6-5 RGB format are converted to 6-bit pixel display values via the following simple integer approximation to the standard NTSC Luminance Conversion formula:
Pixel Value=(R>>2)+(R>>4)+(G>>1)+(G>>4)+(B>>3)

Please note that unlike in the Color Anti-aliasing Mode, the Monochrome Luminance function works solely on the color fields of the current pixel. As a result, the on-chip 2-line ring buffer is not used in this mode.

Implementation Warning: The simplified math given above is used for ease of understanding, not to convey the actual implementation. For example, the use of left-shift and right-shift operators is intended to specify the alignment of the bits from different color components, not to imply that any bits are “lost” during the Luminance Conversion process. For visual display quality, it is imperative that full 10-bit precision is maintained until the complete result is output. Only the final output of the Luminance Conversion process can be truncated to six bits. Implementations that discard the least significant bits during Luminance Computation, prior to the output truncation, are not accepted.

Bits 5-7: Dot Clock Divider

In order to support minimum power drain, secondary display controller 106 supports the ability to reduce the frequency of the panel interface Dot Clock. The value of this field specifies the crystal oscillator divisor minus one, to yield the system Dot Clock frequency. All video timings are derived from the Dot Clock. If this field contains 0, the Dot Clock is equal to the clock frequency of the crystal, whereas a value of 7 yields a Dot Clock of one-eighth the frequency of the crystal. Using a 54.06 MHz crystal, with nominal programmed video timing parameters that yield a 50-Hz panel refresh rate, and varying the Dot Clock divider alone, results in actual panel refresh rates of 50.00 Hz, 25.00 Hz, 16.67 Hz, 12.50 Hz, 10.00 Hz, 8.33 Hz, 7.14 Hz or 6.25 Hz.

Implementation Details: Using the 2× memory clock PLL as the input clock source for the DotClock Divider is one possible method of simplifying the creation of a 50 percent duty cycle DotClock with all divisors.

Bit 8: Video Autosync Mode

If this bit is set, secondary display controller 106 automatically resets all its internal video timing counters whenever a DisplayLoad sequence is initiated, i.e., on encountering the trailing edge of the first Vsyncln pulse. This mode is intended for use when the Vsyncln and VsyncOut frequencies are programmed to be identical. If they are not, this mode should be used with caution.

For example, if the DotClock Divisor of secondary display controller 106 is programmed to support a 25 Hz panel refresh rate, but primary display controller 104 of the system is configured for a 50 Hz output rate, only the first ˜½ of the panel is refreshed, prior to the video timers of secondary display controller 106 being reset. By running the input and output frequencies at the same rate, artifacts such as the above can be avoided. Advanced applications may, however, attempt to utilize the Scan Line Interrupt capability of the secondary display controller 106 to support mixed frame rate usage.

Please note that Video Auto Sync only functions when secondary display controller 106 is listening to the video input port, i.e., when a DisplayLoad sequence is in process. This prevents display problems that might occur when the outputs of the re-initializing primary display controller 106 inadvertently interfere with the video refresh of secondary display controller 106.

Bit 9: Display Timeout Enable

When this bit is set to 1, secondary display controller 106 automatically stops the display process.

When Display Timeout Value video frames have been output without a Display Load sequence occurring, performing a Display Load automatically resets the internal timeout counter to the value in the Display Timeout Value register. When this bit is set to 0, secondary display controller 106 continues display output refresh that is independent of DisplayLoad cycles.

Bits 10: Scan Line Interrupt Enable

Setting this bit to 1 enables secondary display controller 106 Scan Line Interrupt output to be generated during the video scan line, which is programmed into the Scan Line Interrupt Value register. This interrupt becomes active at the start of the programmed line and remains active for one-line duration of each frame. This sequence continues as long as the Scan Line Interrupt Enable bit is 1.

Bits 11-14: Reserved

These read-only bits are reserved and always return a value of 0 on reads.

Bit 15: Self-Test Mode

At power-up, secondary display controller 106 samples the BIST0 pin to determine if it should enter normal operation, BIST0 Low, a self-test operation or BIST0 High. The state of the BIST pin is copied to the Self-test mode pin on exiting reset. Software may also initiate entry into the BIST Mode by writing this bit with a 1, and can restore normal operation by writing this bit with a 0.

Various embodiments of the invention ensure that power consumption is reduced while a display subsystem is being driven. The secondary display controller can refresh the display device autonomously, independent of the processor and the first display controller, thereby eliminating the need for continuous processor intervention. The first and second display controllers and the display device can be turned off during periods of prolonged inactivity, resulting in significant savings in the power consumption of the display system.

Various embodiments of the invention do not require dedicated and expensive hardware and provide an ideal system, for use in electronic devices in cost- and power-sensitive applications.

The system, as described in the present invention or any of its components, may be embodied in the form of a computer system. Typical examples of a computer system include a general-purpose computer, a programmed microprocessor, a micro-controller, a peripheral integrated circuit element, and other devices or arrangements of devices that are capable of implementing the steps constituting the method of the present invention.

The computer system comprises a computer, an input device, a display unit and the Internet. The computer comprises a microprocessor, which is connected to a communication bus. The computer also includes a memory, which may include Random Access Memory (RAM) and Read Only Memory (ROM). Further, the computer system comprises a storage device, which can be a hard disk drive or a removable storage drive such as a floppy disk drive, an optical disk drive, and the like. The storage device can also be other similar means for loading computer programs or other instructions on the computer system.

The computer system executes a set of instructions that are stored in one or more storage elements, to process input data. The storage elements may also hold data or other information, as desired, and may be an information source or physical memory element present in the processing machine.

The set of instructions may include various commands that instruct the processing machine to execute specific tasks such as the steps constituting the method of the present invention. The set of instructions may be in the form of a software program. The software may be in various forms such as system software or application software. Further, the software may be in the form of a collection of separate programs, a program module with a larger program, or a portion of a program module. The software may also include modular programming in the form of object-oriented programming. Processing of input data by the processing machine may be in response to user commands, to the results of previous processing, or to a request made by another processing machine.

While the embodiments of the invention have been discussed and described, the invention is not limited to these embodiments only. A number of changes and modifications can be thought of, without moving away from the scope of the invention, as discussed in the claims.

What is claimed is:

1. A method for reducing power consumption of a display subsystem present in a computational unit, the computational unit comprising a processor, a primary display controller, and a secondary display controller, the method comprising the steps of:
a. switching the primary display controller from an active state to an inactive state if no new refresh data is generated by the processor; and
b. commanding the secondary display controller to refresh the display device independently of the primary display controller and the processor, the display device being present in the display subsystem, the secondary display controller consuming substantially lower power than the primary display controller.

2. The method of claim 1 further comprising the step of converting the refresh data present in the primary display controller into a reduced bit form, the reduced bit form being visually indistinguishable from the refresh data present in the primary display controller.

3. The method of claim 2, wherein the reduced bit form is stored in a frame buffer, the frame buffer being connected to the secondary display controller.

4. The method of claim 2, wherein the step of converting the refresh data present in the primary display controller to a reduced bit form comprises the steps of:
a) processing the red bits of refresh data present in the primary display controller to form a reduced bit form, the red bits of the refresh data of the primary display controller and the reduced bit form corresponding to the first pixel of the first line of the display device;
b) processing the green bits of the refresh data present in the primary display controller to form a reduced bit form, the green bits of the refresh data of the primary display controller and the reduced bit form corresponding to the second pixel of the first line of the display device; and
c) processing the blue bits of the refresh data present in the primary display controller to form a reduced bit form, the blue bits of the refresh data of the primary display controller and the reduced bit form corresponding to the third pixel of the first line of the display device.

5. The method of claim 4 further comprising the step of processing the refresh data present in the primary display controller for each pixel of each line of the display device, wherein the color assignment for each horizontal offset varies from the immediately adjacent line.

6. The method of claim 2 further comprising the step of anti-aliasing the reduced bit form, the step of anti-aliasing the reduced bit form comprising the step of determining the value of each pixel of each line of the display device, the antialiased value of each of the pixel being determined by computing the values of the current pixel and the values of the neighboring pixels.

7. The method of claim 2, wherein the step of processing the refresh data present in the primary display controller to form a reduced bit form comprises the step of converting the input color information of the refresh data present in the primary display controller into a monochromatic representation, the monochromatic representation matching the human luminosity perception of the refresh data present in the primary display controller.

8. The method of claim 2, wherein the step of processing the refresh data present in the primary display controller comprises the step of passing the green component of the refresh data present in the primary display controller in another form, the another form being materially-visually identical to the green content of the refresh data present in the primary display controller.

9. The method of claim 1 further comprising the steps of:
a. commanding the primary display controller to enter an active state from an inactive state when the processor generates new refresh data;
b. commanding the secondary display controller that a new refresh data has been generated by the processor; and
c. commanding the primary display controller to refresh the display device.

10. The method of claim 9 further comprising the step of converting a single refresh data frame present in the primary display controller to a reduced bit form, the step of converting being performed immediately prior to commanding the secondary display controller to refresh the display device, the step of converting thereby enhancing the efficiency of the display process.

11. The method of claim 1, wherein the secondary display controller is capable of entering an inactive state, the inactive state being entered by disabling the refreshing of the display device without the processor intervention.

12. The method of claim 11, wherein the secondary display controller is capable of turning off the display device completely.

13. The method of claim 11, wherein the secondary display controller is capable of autonomously switching from the inactive state to an active state upon receipt of an input signal from one or more input devices, the one or more input devices being connected to the computational unit, the input signal being received by the secondary display controller without processor intervention.

14. The method of claim 13, wherein the input signal from the one or more input devices connected to the computational unit is received by a pin present in the secondary display controller.

15. The method of claim 11, wherein the secondary display controller is capable of autonomously switching from the inactive state to an active state upon receipt of an input signal from one or more input devices, the one or more input devices being connected to the computational unit, the input signal being received by the secondary display controller via processor intervention.

16. The method of claim 1 for reducing power consumption of a display subsystem present in a computational unit being performed by a data processor according to computer-executable instructions stored on a computer-readable medium.

17. A system for reducing power consumption of a display subsystem present in a computational unit, the system comprising:
a) a processor, the processor generating refresh data to be displayed by the display device, the display device being present in the display subsystem;
b) a primary display controller, the primary display controller refreshing the display device with the refresh data; and
c) a secondary display controller, the secondary display controller refreshing the display device with the refresh data independently of the primary display controller and the processor, the secondary display controller comprising:
i. a frame buffer, the frame buffer storing a refresh frame for refreshing the display device independently of the primary display controller and the processor.

18. The system of claim 17, wherein the secondary display controller further comprises an input port, the input port receiving the refresh data present in the primary display controller for each pixel of each line present in the display device, the refresh data being generated by the processor.

19. The system of claim 17, wherein the secondary display controller further comprises an output port, the output port being connected to a compatible Thin Film Transistor (TFT) panel row and column driver Integrated Circuits (ICs) present in the computational unit, the TFT panel row and column driver ICsproviding the reduced bit form to the display device through an output port, the reduced bit form being used for refreshing the display device independent of the processor.

20. The system of claim 17, wherein the secondary display controller further comprises one or more clocks, the one or more clocks running synchronously with one or more clocks of the primary display controller.

21. The system of claim 17, wherein the secondary display controller further comprises:
a. a first pin, the first pin determining which of the two display controllers refresh the display device, the primary display controller refreshing the display device if the first pin is in an active state, the secondary display controller refreshing the display device if the first pin is in an inactive state;
b. a second pin, the second pin being set to an active state if the secondary display controller is in an inactive state;
c. a third pin, the third pin driving the secondary display controller from the inactive state to the active state when the processor receives one or more inputs from one or more input devices, the one or more input devices being connected to the processor;
d. a fourth pin, the fourth pin facilitating communication of the secondary display controller with the processor; and

22. The system of claim 21, wherein the secondary display controller further comprises fifth pin, the fifth pin receiving input signal from the one or more input devices.

23. The system of claim 17, wherein the secondary display controller further comprises:
a. a processing module, the processing module processing refresh data present in the primary display controller to form a reduced bit form, the processing module comprising:
i. a determining module, the determining module determining the value of each pixel of each line of the display device.

24. A system for reducing power consumption of a display subsystem present in a computational unit, the system comprising:
a. a processor, the processor generating refresh data to be displayed by the display device, the display device being present in the display subsystem;
b. a primary display controller, the primary display controller refreshing the display device with the refresh data;
c. a frame buffer, the frame buffer storing a refresh frame for refreshing the display device; and
d. a secondary display controller, the secondary display controller refreshing the display device with the refresh data independently of the primary display controller and the processor, wherein either the primary or the secondary display controller may dynamically be commanded to refresh the display device.

25. A secondary display controller, the secondary display controller comprising:
a. an input port, the input port receiving refresh data present in a primary display controller for each pixel of each of line present in the display device connected to a Transistor-Transistor Logic (TTL) compatible Thin Film Transistor (TFT) display controller;
b. an output port, the output port being connected to a compatible TFT panel row and column driver Integrated Circuits (ICs) for supporting display output on compatible TFT displays;
c. a frame buffer, the frame buffer storing a refresh frame for refreshing the display device independent of the primary display controller and the processor;
d. a Synchronous Dynamic Random Access Memory (SDRAM) interface port, the SDRAM interface port being connected to the frame buffer; and
e. one or more clocks, the one or more clocks refreshing the display device.

26. The secondary display controller of claim 25 further comprising:
a. a first pin, the first pin determining which of the two display controllers refresh the display device, the primary display controller refreshing the display device if the first pin is in an active state, the secondary display controller refreshing the display device if the first pin is in an inactive state;
b. a second pin, the second pin being set to an active state if the secondary display controller is in an inactive state;
c. a third pin, the third pin driving the secondary display controller from the inactive state to the active state when the processor receives one or more inputs from one or more input devices, the one or more input devices being connected to the processor; and
d. a fourth pin, the fourth pin facilitating communication of the secondary display controller with the processor.

27. The secondary display controller of claim 26 further comprising a fifth pin, the fifth pin receiving input signal from the one or more input devices.

28. The secondary display controller of claim 26 further comprising:
a. a processing module, the processing module processing refresh data present in the primary display controller to form a reduced bit form, the processing module comprising:
i. a determining module, the determining module determining the value of each pixel of each line of the display device.
